(19) United States
(12) Patent Application Publication
(10) Pub. No.: US 2026/0135190 A1
(43) Pub. Date: May 14, 2026

(54) BATTERY PACK

(71) Applicant: SAMSUNG SDI CO., LTD., Yongin-si (KR)

(72) Inventors: YONGRACK KOO, Yongin-si (KR); TAEMYUNG KIM, Yongin-si (KR)

(73) Assignee: SAMSUNG SDI CO., LTD., Yongin-si (KR)

(21) Appl. No.: 19/211,058

(22) Filed: May 16, 2025

(30) Foreign Application Priority Data
Nov. 11, 2024 (KR) 10-2024-0159031

(51) Int. Cl. H01M 10/6568; H01M 10/613; H01M 10/643; H01M 50/213; H01M 50/507; H01M 50/51

(52) U.S. Cl. CPC H01M 10/6568; H01M 10/613; H01M 10/643; H01M 50/213; H01M 50/507; H01M 50/51

(57) ABSTRACT

Provided is a battery pack including a case, a plurality of battery cells which are accommodated in the case, are connected in series, and each has a flow path formed in a central portion thereof, and a pump configured to circulate a cooling fluid along the flow path.

### CROSS-REFERENCE TO RELATED APPLICATIONS

This present application claims priority to and the benefit under 35 U.S.C. § 119(a)-(d) of Korean Patent Application No. 10-2024-0159031, filed on Nov. 11, 2024, in the Korean Intellectual Property Office, the entire disclosure of which is incorporated herein by reference.

### FIELD

The present disclosure relates to a battery pack.

### BACKGROUND

Secondary batteries have been developed rapidly in recent years due to advantages of being rechargeable and having a small size and high capacity, and as a result, the use of the secondary batteries is also rapidly increasing. Among these secondary batteries, lithium-ion (Li-ion) batteries that use lithium ions (Li-ion) as electrode active materials may be classified into can-type batteries and pouch-type batteries according to a shape of a container in which an electrode assembly is accommodated.

In can-type lithium secondary batteries, an electrode assembly is embedded in a can made of a metal containing aluminum or the like. Typically, can-type secondary batteries use liquid electrolytes.

For example, can-type secondary batteries may be classified into prismatic batteries and cylindrical batteries according to a shape. A container is thinly formed in a rectangular parallelepiped shape, and thus a prismatic battery is widely used in electrical devices such as mobile phones. A cylindrical battery is widely used in relatively high-capacity electronic and electrical devices and is often used in a form in which a plurality of cylindrical secondary batteries are coupled to form a battery pack.

### SUMMARY

The present disclosure provides a battery pack with improved cooling efficiency.

However, the technical objects to be solved by the present disclosure are not limited to the above, and other objects that are not described herein will be clearly understood by those skilled in the art from the following disclosure.

Embodiments of the present disclosure provides a battery pack including a case, a plurality of battery cells which are accommodated in the case, are connected in series, and each has a flow path formed in a central portion thereof, and a pump configured to circulate a cooling fluid along the flow path.

In embodiments, each of the plurality of battery cells may include a cylindrical can including a bottom portion, and a cap assembly configured to cover one surface of the cylindrical can, and an opening may be formed in each of central portions of the bottom portion and the cap assembly so that the flow path, which passes through the central portion of the battery cell and is externally connected, may be formed.

In embodiments, each of the plurality of battery cells may further include a center pin positioned at the central portion, and herein the center pin may communicate with the cap assembly and the bottom portion.

In embodiments, the center pin may have a hollow circular pipe shape.

In embodiments, a concave portion may be positioned at the central portion of the bottom portion, and a protrusion may be positioned at the central portion of the cap assembly, wherein the protrusion may be disposed at one side of the flow path, and the concave portion may be disposed at another side of the flow path.

In embodiments, the plurality of battery cells connected in series may be coupled such that the protrusion of the battery cell corresponds to the concave portion of the battery cell adjacent thereto.

In embodiments, the bottom portion may be electrically connected to a negative electrode tab, and the cap assembly may be electrically connected to a positive electrode tab.

In embodiments, a plurality of guide portions may be disposed along an outer circumference of the concave portion to be spaced apart from one another.

In embodiments, the plurality of guide portions may be configured to guide the protrusion to be coupled to correspond to the concave portion.

In embodiments, one area of the protrusion may be coupled to the concave portion, and the guide portion may be welded to another area of the protrusion which is not coupled to the concave portion.

In embodiments, the protrusion may be electrically connected to the concave portion.

In embodiments, an insulating plate may be disposed between the cylindrical can and the cap assembly.

Embodiments of the present disclosure provides a battery pack including a case, a connection group comprising a plurality of battery cells which are accommodated in the case, are connected in series, and each has a flow path formed in a central portion thereof, a first busbar disposed at one side of the connection group, a second busbar disposed at another side of the connection group, and a pump configured to circulate a cooling fluid along the flow path, wherein a plurality of connection groups are disposed in the case, and the first busbar and the second busbar electrically connect the plurality of connection groups in parallel.

In embodiments, each of the plurality of battery cells may include a cylindrical can including a bottom portion, and
a cap assembly configured to cover one surface of the cylindrical can, and an opening may be formed in each of central portions of the bottom portion and the cap assembly so that the flow path, which passes through the central portion of the battery cell and is externally connected, may be formed.

In embodiments, each of the plurality of battery cells may further include a center pin positioned at the central portion,
and the center pin may communicate with the opening of the cap assembly and the opening of the bottom portion.

In embodiments, the center pin may have a hollow circular pipe shape.

In embodiments, a concave portion may be positioned at the central portion of the bottom portion, and a protrusion may be positioned at the central portion of the cap assembly, wherein the protrusion may be disposed at one side of the flow path, and the concave portion may be disposed at another side of the flow path.

In embodiments, the plurality of battery cells connected in series may be coupled such that the protrusion of the battery cell corresponds to the concave portion of the battery cell adjacent thereto.

In embodiments, the protrusion may be electrically connected to the concave portion.

In embodiments, a plurality of guide portions are disposed along an outer circumference of the concave portion to be spaced apart from one another.

### BRIEF DESCRIPTION OF THE DRAWINGS

The accompanying drawings illustrate embodiments of the present disclosure and, together with the following detailed description, serve to provide further understanding of the technical spirit of the present disclosure. However, the present disclosure is not to be construed as being limited to the details shown in the drawings, in which:

FIG. 1 is a schematic perspective view illustrating an example of a battery pack according to embodiments of the present disclosure;

FIG. 2 is a schematic perspective view illustrating an example of a battery cell accommodated in the battery pack of FIG. 1;

FIG. 3 is a view of the battery cell viewed in direction A of FIG. 2;

FIG. 4 is a schematic cross-sectional view illustrating an example of the battery cell of FIG. 2;

FIG. 5 is a view illustrating a temperature difference between a central portion and the outside of the battery cell;

FIG. 6 is a schematic perspective view illustrating another example of a battery cell accommodated in the battery pack of FIG. 1;

FIG. 7 is a view of the battery cell viewed in direction B of FIG. 6;

FIG. 8 is a schematic cross-sectional view illustrating an example of the battery cell of FIG. 6;

FIG. 9 is a schematic cross-sectional view illustrating an example of a method of coupling the battery cell of FIG. 6; and

FIG. 10 is a schematic cross-sectional view illustrating an example of a battery pack according to embodiments of the present disclosure.

### DETAILED DESCRIPTION

Hereinafter, embodiments of the present disclosure will be described with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best description. Accordingly, embodiments disclosed in the present specification and configurations illustrated in the drawings are merely most exemplary embodiments of the present disclosure and do not represent all of the technical ideas of the present disclosure, and thus it should be understood that there may be various equivalents and modifications that may substitute these at the time of filing of the present application.

Further, “comprise and include” and/or “comprising and including” used in this specification should be interpreted as specifying the presence of described shapes, numbers, steps, operations, members, elements, and/or groups thereof and do not exclude the presence or addition of other shapes, numbers, operations, members, elements, and/or groups thereof.

In some embodiments, for a better understanding of the present disclosure, the accompanying drawings are not illustrated on an actual scale and sizes of some elements may be exaggerated. In some embodiments, the same reference numbers may be assigned to the same components in different embodiments.

It will be understood that, although the terms first, second, and the like are used herein to describe various components, these components should not be limited by these terms. These terms are only used to distinguish one component from another component, and a first component may also be a second component unless particularly described otherwise.

Through the specification, each component may be singular or plural unless particularly described otherwise.

Arrangement of any component “on” a component includes not only the arrangement in which any component is disposed in contact with the top surface (or bottom surface) of the component, but also the arrangement in which other components may be disposed between the component and any component disposed on (or under) the component.

Also, when it is said that a first element is “connected” or “coupled” to a second element, this may mean that the elements are directly connected or coupled to one another, but it should be understood that a third element may be “interposed” between the elements or the elements may be “connected” or “coupled” to one another via the third element. Further, the term “electrically coupled” may mean not only “directly coupled” but also may include “coupled via other interposing component.”

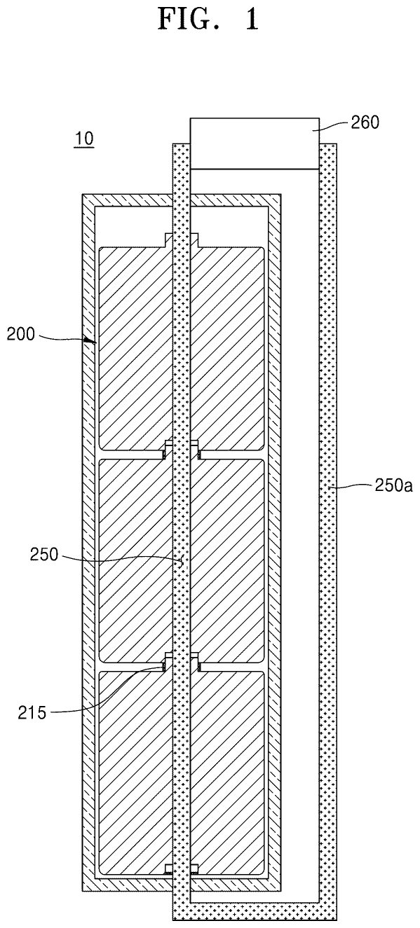

FIG. 1 is a schematic cross-sectional view illustrating an example of a battery pack 10 according to embodiments of the present disclosure.

Referring to FIG. 1, in the battery pack 10 according to embodiments of the present disclosure, a plurality of battery cells 200 may be connected in series and accommodated in a case. In this case, flow paths 250 which communicate with one another may each be formed in one of central portions of the plurality of battery cells 200 that are connected in series, and a pump 260 may be used to circulate a cooling fluid 250a along the flow path 250, thereby cooling the central portions of the plurality of battery cells 200 that are connected in series.

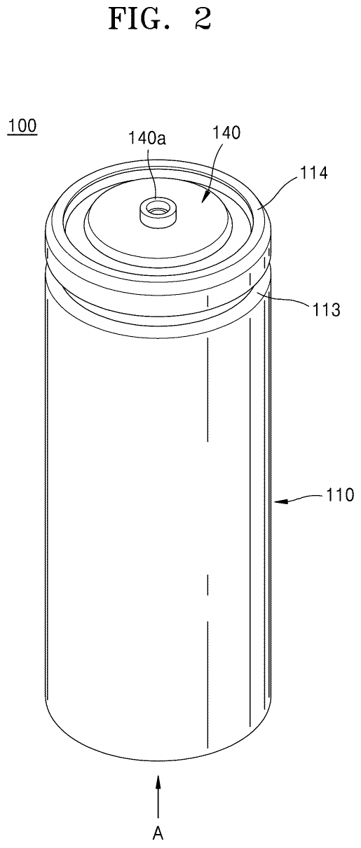

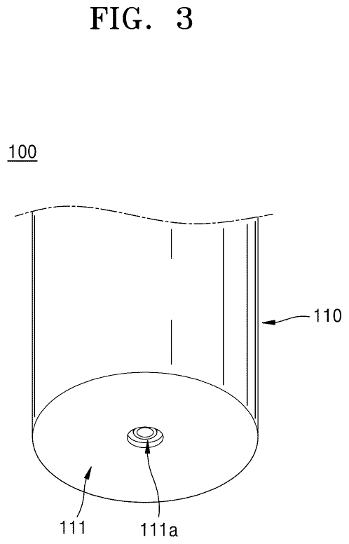

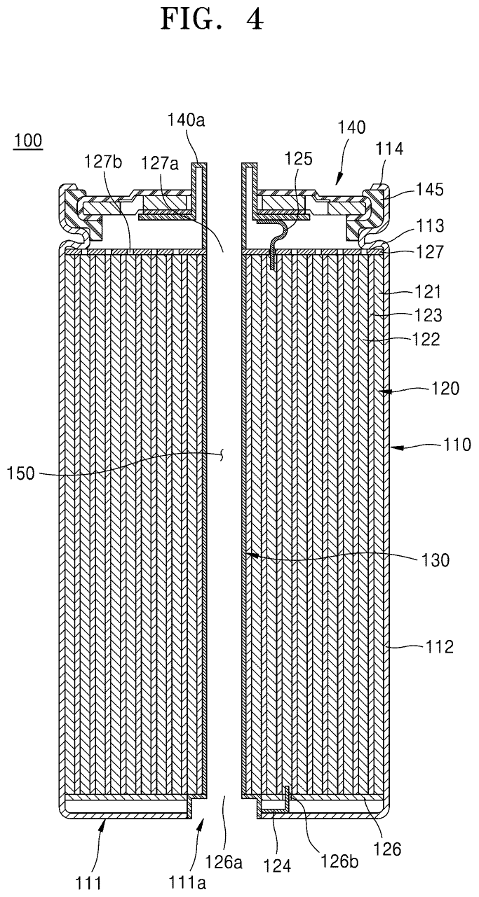

FIG. 2 is a schematic perspective view illustrating an example of a battery cell 100 accommodated in the battery pack 10 of FIG. 1. FIG. 3 is a view of the battery cell 100 viewed in direction A of FIG. 2. FIG. 4 is a schematic cross-sectional view illustrating an example of the battery cell 100 of FIG. 2.

Referring to FIGS. 2 to 4, the battery cell 100 according to embodiments of the present disclosure may include a can 110 that accommodates an electrode assembly 120, a cap assembly 140 that covers one surface of the can 110, and a bottom portion 111 that covers the other surface of the can 110.

The can 110 may include a cylindrical can, and in some embodiments, the cylindrical lithium battery cell 100 may further include a center pin 130 in some cases. In some embodiments, in the battery cell 100 according to the embodiment of the present disclosure, the cap assembly 140 also performs a current interruption operation and thus is also referred to as a current interrupt device in some cases.

The cylindrical can 110 may include the bottom portion 111 having an approximately circular shape and a cylindrical sidewall 112 extending upward from a circumference of the bottom portion 111 by a certain length. During a manufacturing process of the battery cell 100, an upper portion of the cylindrical can 110 is open. Therefore, during an assembly process of the battery cell 100, the electrode assembly 120 and the center pin 130 may be inserted into the cylindrical can 110 together with an electrolyte. The cylindrical can 110 may be made of, for example, steel, stainless steel, aluminum, an aluminum alloy, or an equivalent thereof, but one or more embodiments are not limited thereto.

In some embodiments, in order to prevent the cap assembly 140 from being detached to the outside, the cylindrical can 110 may include a beading part 113 recessed inward below the cap assembly 140, and a crimping part 114 bent inward on the cap assembly 140.

The electrode assembly 120 may be accommodated inside the cylindrical can 110. The electrode assembly 120 may include a negative electrode plate 121 in which a negative electrode active material (for example, graphite or carbon) is applied onto a negative electrode collector plate, a positive electrode plate 122 in which a positive electrode active material (for example, transition metal oxide (LiCoO₂, LiNiO₂, or LiMn₂O₄) is applied onto a positive electrode collector plate, and a separator 123 positioned between the negative electrode plate 121 and the positive electrode plate 122 to prevent a short circuit and enable only the movement of lithium ions. In some embodiments, the negative electrode plate 121, the positive electrode plate 122, and the separator 123 may be wound into an approximately cylindrical shape. Here, for example, although one or more embodiments are not limited thereto, the negative electrode current collector plate may be made of copper (Cu) foil, the positive electrode current collector plate may be made of aluminum (Al) foil, and the separator 123 may be made of polyethylene (PE) or polypropylene (PP).

In some embodiments, a negative electrode tab 124 that protrudes downward and extends by a certain length may be welded to the negative electrode plate 121, and a positive electrode tab 125 that protrudes upward and extends by a certain length may be welded to the positive electrode plate 122, but the opposite is also possible. In some embodiments, for example, although one or more embodiments are not limited thereto, the negative electrode tab 124 may be made of copper (Cu) or nickel (Ni), and the positive electrode tab 125 may be made of aluminum (Al).

In some embodiments, the negative electrode tab 124 of the electrode assembly 120 may be welded to the bottom portion 111 of the cylindrical can 110. Therefore, the cylindrical can 110 may operate as a negative electrode. Of course, conversely, the positive electrode tab 125 may be welded to the bottom portion 111 of the cylindrical can 110, and in this case, the cylindrical can 110 may operate as a positive electrode.

In some embodiments, a first insulating plate 126 coupled to the cylindrical can 110 and having a first hole 126a formed in a central portion thereof and a second hole 126b formed outside the first hole 126a may be disposed between the electrode assembly 120 and the bottom portion 111. The first insulating plate 126 serves to prevent the electrode assembly 120 from being in electrical contact with the bottom portion 111 of the cylindrical can 110. In particular, the first insulating plate 126 serves to prevent the positive electrode plate 122 of the electrode assembly 120 from being in electrical contact with the bottom portion 111. The second hole 126b serves to allow the negative electrode tab 124 to pass therethrough and be welded to the bottom portion 111.

In some embodiments, a second insulating plate 127 coupled to the cylindrical can 110 and having a first hole 127a formed in a central portion thereof and a plurality of second holes 127b formed outside the first hole 127a may be disposed between the electrode assembly 120 and the cap assembly 140. The second insulating plate 127 serves to prevent the electrode assembly 120 from being in electrical contact with the cap assembly 140. In particular, the second insulating plate 127 serves to prevent the negative electrode plate 121 of the electrode assembly 120 from being in electrical contact with the cap assembly 140. The second hole 127b serves to allow the positive electrode tab 125 to pass therethrough and be welded to the cap assembly 140. In some embodiments, the remaining second holes 127b serve to allow an electrolyte to quickly flow into the electrode assembly 120 during an electrolyte injection process.

The center pin 130 may have a hollow circular pipe shape and may be approximately coupled to a central portion of the electrode assembly 120. The center pin 130 may be made of, for example, steel, stainless steel, aluminum, an aluminum alloy, or polybutylene terephthalate, but one or more embodiments are not limited thereto. The center pin 130 may serve to suppress the deformation of the electrode assembly 120 during charging/discharging of a battery and may communicate with the cap assembly 140 and the bottom portion 111 through the first holes 126a and 127a of the first and second insulating plates 126 an 127. In this case, an opening may be formed in each of a central portion of the cap assembly 140 and a central portion of the bottom portion 111 so that a flow path 150 passing through a central portion of the battery cell 100 and connected to the outside may be formed. That is, the opening formed in each of the central portion of the cap assembly 140 and the central portion of the bottom portion 111 may communicate with the center pin 130, and thus the flow path 150 that passes through the central portion of the battery cell 100 and is connected to the outside may be formed. In this case, the flow path 250 may be a separate space separated from the interior of the battery cell 100 in which the electrode assembly 120 and the electrolyte are accommodated.

A positive electrode terminal electrically connected to the positive electrode tab 125 of the battery cell 100 may be positioned at one side of the flow path 150, and a negative electrode terminal electrically connected to the negative electrode tab 124 of the battery cell 100 may be positioned at the other side of the flow path 150.

For example, the positive electrode terminal may be the cap assembly 140 electrically connected to the positive electrode tab 125, and a protrusion 140a may be positioned at the central portion of the cap assembly 140. In this case, the protrusion 140a may be disposed in a form that surrounds the flow path 150.

For example, the negative electrode terminal may be the bottom portion 111 electrically connected to the negative electrode tab 124, and a concave portion 111a may be positioned at the central portion of the bottom portion 111. In this case, the concave portion 111a may be disposed in a form that surrounds the flow path 250.

For example, a protruding length of the protrusion 140a may be 1.5 to 2 times a depth of the concave portion 111a so that approximately half of a length of the protrusion 140a may be inserted into and coupled to the concave portion 111a. When different battery cells 100 are coupled to one another, the protrusion 140a and the concave portion 111a may be coupled and electrically connected to one another one another, and at the same time, the flow paths 150 of the battery cells 100 may also communicate with one another and form one flow path 150.

As an optional embodiment, a packing made of a material including rubber or silicone may be positioned on a surface of the concave portion 111a, thereby preventing a cooling fluid flowing along the flow path 150 from leaking out to the outside when the protrusion 140a and the concave portion 111a are coupled to one another.

For example, since the protrusion 140a is coupled to correspond to the concave portion 111a, the battery cells 100 according to embodiments of the present disclosure may be electrically connected to one another so that a busbar that increases resistance does not need to be used when different battery cells 100 are connected to one another, and a distance between the battery cells 100 may be decreased to reduce resistance.

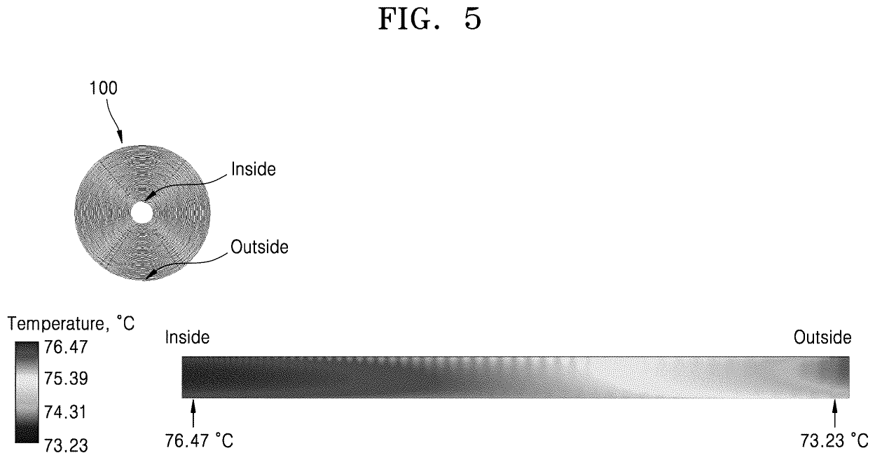

FIG. 5 is a view illustrating a temperature difference between the central portion and the outside of the battery cell 100.

Referring to FIG. 5, it may be confirmed that a temperature of the battery cell 100 with a cylindrical shape is highest at the central portion during use and gradually decreases toward the outside. That is, since the central portion of the battery cell 100 during use may be most severely heated, cooling the central portion may assist in maintaining the performance of the battery cell 100.

As a result, in the battery pack 10 according to embodiments of the present disclosure, the opening formed in each of the central portions of the cap assembly 140 and the bottom portion 111 of the battery cell 100 may communicate with the center pin 130 to form the flow path 150 at a central portion, and a cooling fluid may be allowed to circulate along the flow path 150 to cool the central portion which is a portion of the battery cell 100 that is most severely heated, thereby improving the efficiency of cooling the battery cell 100.

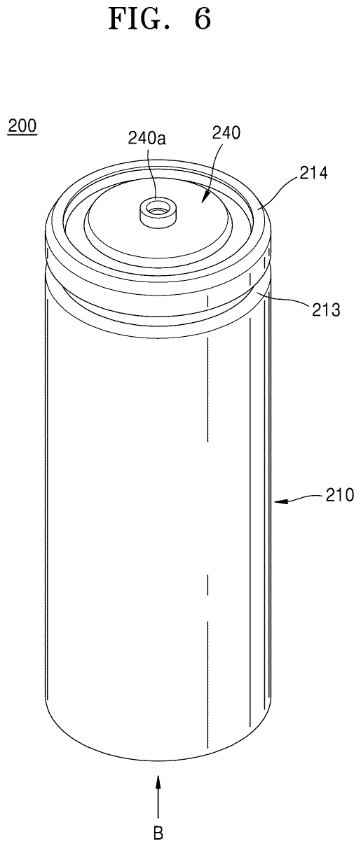

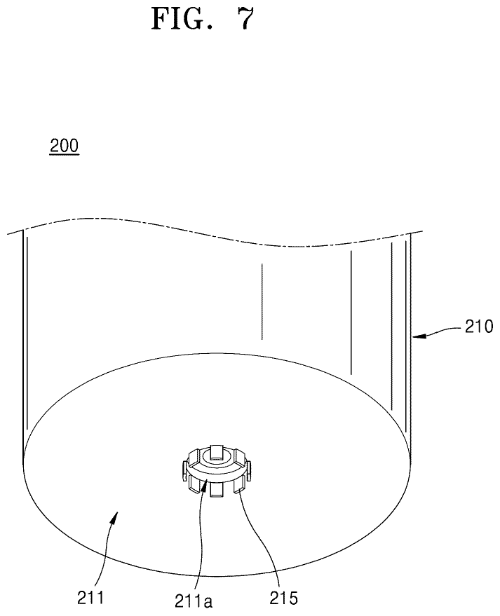

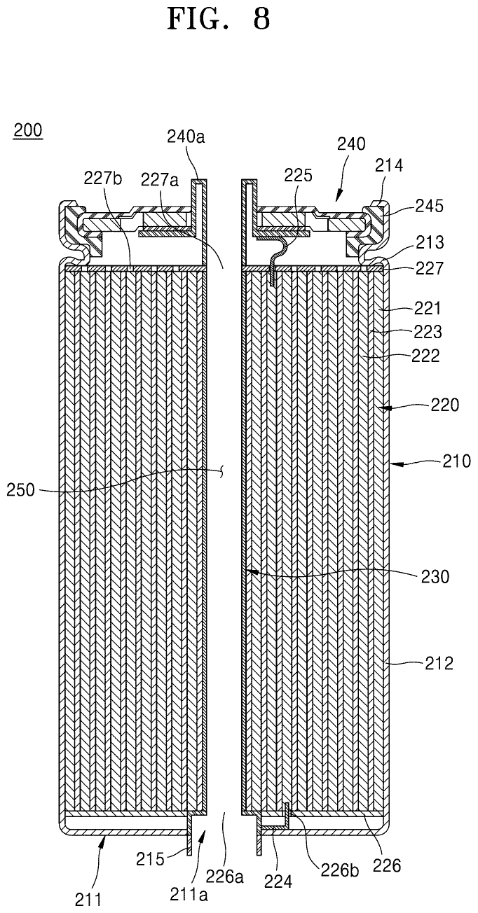

FIG. 6 is a schematic perspective view illustrating another example of a battery cell 200 accommodated in the battery pack 10 of FIG. 1. FIG. 7 is a view of the battery cell 200 viewed in direction B of FIG. 6. FIG. 8 is a schematic cross-sectional view illustrating an example of the battery cell 200 of FIG. 6.

Referring to FIGS. 6 to 8, the battery cell 200 according to another embodiment of the present disclosure may include a cylindrical can 210, an electrode assembly 220, and a cap assembly 240. In some embodiments, the cylindrical lithium ion battery cell 200 may further include a center pin 230 in some cases. In some embodiments, in the battery cell 200 according to the embodiment of the present disclosure, the cap assembly 240 also performs a current interruption operation and thus is also referred to as a current interrupt device in some cases.

The cylindrical can 210 may include a bottom portion 211 having an approximately circular shape and a cylindrical sidewall 212 extending upward from a circumference of the bottom portion 211 by a certain length. During a manufacturing process of the battery cell 200, an upper portion of the cylindrical can 210 is open. Therefore, during an assembly process of the battery cell 200, the electrode assembly 220 and the center pin 230 may be inserted into the cylindrical can 210 together with an electrolyte. The cylindrical can 210 may be made of, for example, steel, stainless steel, aluminum, an aluminum alloy, or an equivalent thereof, but one or more embodiments are not limited thereto.

In some embodiments, in order to prevent the cap assembly 240 from being detached to the outside, the cylindrical can 210 may include a beading part 213 recessed inward below the cap assembly 240, and a crimping part 214 bent inward on the cap assembly 240.

The electrode assembly 220 may be accommodated inside the cylindrical can 210. The electrode assembly 220 may include a negative electrode plate 221 in which a negative electrode active material (for example, graphite or carbon) is applied onto a negative electrode collector plate, a positive electrode plate 222 in which a positive electrode active material (for example, transition metal oxide (LiCoO₂, LiNiO₂, or LiMn₂O₄) is applied onto a positive electrode collector plate, and a separator 223 positioned between the negative electrode plate 221 and the positive electrode plate 222 to prevent a short circuit and enable only the movement of lithium ions. In some embodiments, the negative electrode plate 221, the positive electrode plate 222, and the separator 223 may be wound into an approximately cylindrical shape. Here, for example, although one or more embodiments are not limited thereto, the negative electrode current collector plate may be made of copper (Cu) foil, the positive electrode current collector plate may be made of aluminum (Al) foil, and the separator 223 may be made of PE or PP.

In some embodiments, a negative electrode tab 224 that protrudes downward and extends by a certain length may be welded to the negative electrode plate 221, and a positive electrode tab 225 that protrudes upward and extends by a certain length may be welded to the positive electrode plate 222, but the opposite is also possible. In some embodiments, for example, although one or more embodiments are not limited thereto, the negative electrode tab 224 may be made of copper (Cu) or nickel (Ni), and the positive electrode tab 225 may be made of aluminum (Al).

In some embodiments, the negative electrode tab 224 of the electrode assembly 220 may be welded to the bottom portion 211 of the cylindrical can 210. Therefore, the cylindrical can 210 may operate as a negative electrode. Of course, conversely, the positive electrode tab 225 may be welded to the bottom portion 211 of the cylindrical can 210, and in this case, the cylindrical can 210 may operate as a positive electrode.

In some embodiments, a first insulating plate 226 coupled to the cylindrical can 210 and having a first hole 226a formed in a central portion thereof and a second hole 226b formed outside the first hole 226a may be disposed between the electrode assembly 220 and the bottom portion 211. The first insulating plate 226 serves to prevent the electrode assembly 220 from being in electrical contact with the bottom portion 211 of the cylindrical can 210. In particular, the first insulating plate 226 serves to prevent the positive electrode plate 222 of the electrode assembly 220 from being in electrical contact with the bottom portion 211. The second hole 226b serves to allow the negative electrode tab 224 to pass therethrough and be welded to the bottom portion 211.

In some embodiments, a second insulating plate 227 coupled to the cylindrical can 210 and having a first hole 227a formed in a central portion thereof and a plurality of second holes 227b formed outside the first hole 227a may be disposed between the electrode assembly 220 and the cap assembly 240. The second insulating plate 227 serves to prevent the electrode assembly 220 from being in electrical contact with the cap assembly 240. In particular, the second insulating plate 227 serves to prevent the negative electrode plate 221 of the electrode assembly 220 from being in electrical contact with the cap assembly 240. The second hole 227b serves to allow the positive electrode tab 225 to pass therethrough and be welded to the cap assembly 240. In some embodiments, the remaining second holes 227b serve to allow an electrolyte to quickly flow into the electrode assembly 220 during an electrolyte injection process.

The center pin 230 may have a hollow circular pipe shape and may be approximately coupled to a central portion of the electrode assembly 220. The center pin 230 may be made of, for example, steel, stainless steel, aluminum, an aluminum alloy, or polybutylene terepthalate, but one or more embodiments are not limited thereto. This center pin 230 may serve to suppress the deformation of the electrode assembly 220 during charging/discharging of a battery and may communicate with the cap assembly 240 and the bottom portion 211 through the first holes 226a and 227a of the first and second insulating plates 226 an 227. In this case, an opening may be formed in each of a central portion of the cap assembly 240 and a central portion of the bottom portion 211 so that a flow path 250 passing through a central portion of the battery cell 200 and connected to the outside may be formed. That is, the opening formed in each of the central portion of the cap assembly 240 and the central portion of the bottom portion 211 may communicate with the center pin 230, and thus the flow path 250 that passes through the central portion of the battery cell 200 and is connected to the outside may be formed. In this case, the flow path 250 may be a separate space separated from the interior of the battery cell 200 in which the electrode assembly 220 and the electrolyte are accommodated.

A positive electrode terminal electrically connected to the positive electrode tab 225 of the battery cell 200 may be positioned at one side of the flow path 250, and a negative electrode terminal electrically connected to the negative electrode tab 224 of the battery cell 200 may be positioned at the other side of the flow path 250.

For example, the positive electrode terminal may be the cap assembly 240 electrically connected to the positive electrode tab 225, and a protrusion 240a may be positioned at the central portion of the cap assembly 240. In this case, the protrusion 240a may be disposed in a form that surrounds the flow path 250.

For example, the negative electrode terminal may be the bottom portion 211 electrically connected to the negative electrode tab 224, and a concave portion 211a may be positioned at the central portion of the bottom portion 211. In this case, the concave portion 211a may be disposed in a form that surrounds the flow path 250.

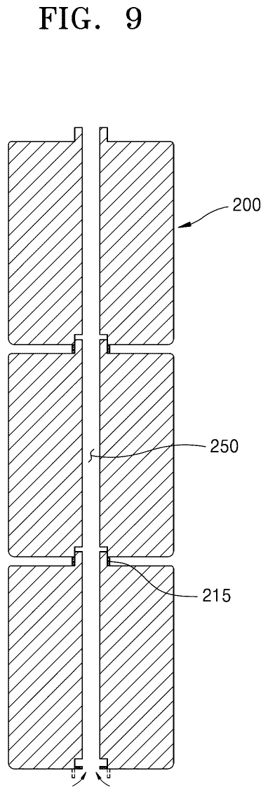

FIG. 9 is a schematic cross-sectional view illustrating an example of a method of coupling the battery cell 200 of FIG. 6.

Referring to FIG. 9, a protruding length of the protrusion 240a may be 1.5 to 2 times a depth of the concave portion 211a. When different battery cells 200 are coupled to one another, the protrusion 240a and the concave portion 211a may be coupled and electrically connected to one another, and at the same time, the flow paths 250 of the battery cells 200 may communicate with one another and form one flow path 250.

In this case, in the concave portion 211a, a plurality of guide portions 215 may be disposed along an outer circumference of the concave portion 211a to be spaced apart from one another. The guide portions 215 may serve to guide the protrusion 240a to be coupled to the concave portion 211a.

For example, a length of the protrusion 240a of the battery cell 200 may be 1.5 to 2 times the depth of the concave portion 211a so that approximately half of the protrusion 240a may be coupled to the concave portion 211a. The guide portions 215 may be welded to the remaining area of the protrusion 240a to serve to allow different battery cells 200 to be firmly coupled when coupled to one another. In some embodiments, when not in use, the guide portion 215 may be bent toward the concave portion 211a and seated on the concave portion 211a.

As an optional embodiment, a packing made of a material including rubber or silicone may be positioned on a surface of the concave portion 211a, thereby preventing a cooling fluid flowing through the flow path 250 from leaking out to the outside when the protrusion 240a and the concave portion 211a are coupled to one another.

For example, since the protrusion 240a is coupled to correspond to the concave portion 211a, the battery cells 200 according to embodiments of the present disclosure may be electrically connected to one another so that a busbar that increases resistance does not need to be used when different battery cells 200 are connected to one another, and a distance between the battery cells 200 may be decreased to reduce resistance.

For example, a temperature of the battery cell 200 with a cylindrical shape during use may be highest at the central portion and may gradually decrease toward the outside. That is, since the central portion of the battery cell 200 during use may be most severely heated, cooling the central portion may assist in maintaining the performance of the battery cell 200.

As a result, in the battery pack 10 according to embodiments of the present disclosure, the opening formed in each of the central portions of the cap assembly 240 and the bottom portion 211 of the battery cell 200 may communicate with the center pin 230 to form the flow path 250 at a central portion, and a cooling fluid may be allowed to circulate along the flow path 250 to cool the central portion which is a portion of the battery cell 200 that is most severely heated, thereby improving the efficiency of cooling the battery cell 200.

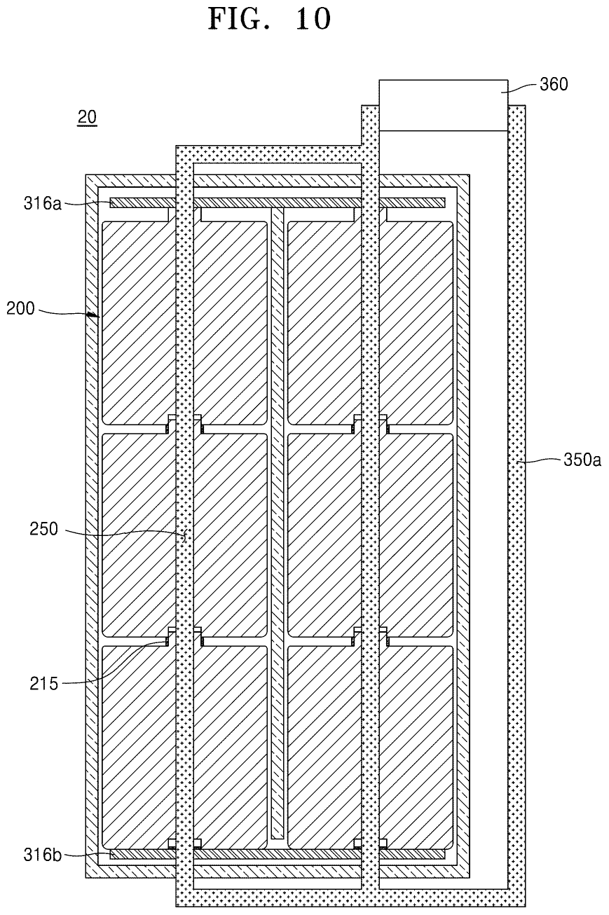

FIG. 10 is a schematic cross-sectional view illustrating an example of a battery pack 20 according to another embodiment of the present disclosure.

Referring to FIG. 10, in the battery pack 20 according to another embodiment of the present disclosure, a plurality of battery cells 200 may be connected in series and accommodated in a case. In this case, flow paths 250 which communicate with one another may each be formed in one of central portions of the plurality of battery cells 200 that are connected in series, and a pump 360 may be used to circulate a cooling fluid 350a along the flow path 250, thereby cooling the central portions of the plurality of battery cells 200 that are connected in series.

In this case, the plurality of battery cells 200 connected in series may be electrically connected by coupling a protrusion positioned at one side of the flow path 250 and a concave portion positioned at the other side thereof. In this case, the protrusion may be guided and coupled to the concave portion by a guide portion 215 disposed at an outer circumference of the concave portion.

For example, a protruding length of the protrusion may be 1.5 to 2 times a depth of the concave portion so that approximately half of a length of the protrusion may be inserted into the concave portion. Thus, the guide portion 215 may be welded to the remaining portion of the protrusion that is not inserted. In this way, the guide portion 215 may be welded to the remaining portion of the protrusion that is not inserted into the concave portion, thereby improving a coupling force between the battery cells 200 connected in series.

In some embodiments, a plurality of connection groups including the battery cells 200 connected in series in this way may be accommodated in the case of the battery pack 20, and the connection groups may be connected in parallel by a first busbar 316a and a second busbar 316b disposed at upper and lower sides, respectively.

The busbar 316a disposed at the upper side electrically connects positive electrode terminals of each connection group, and the busbar 316b disposed at the lower side electrically connects negative electrode terminals of each connection group, thereby connecting respective connection groups in parallel to improve the capacity of the battery pack 20.

In some embodiments, the battery cells 200 connected in series and other battery cells 200 connected in series and connected in parallel with the battery cells 200 may form one flow path 250, and a pump 360 may be used to allow the cooling fluid 350a to circulate along the flow path 250.

As a result, the battery pack 20 according to embodiments of the present disclosure has the flow paths 250 which communicate with one another and are each formed in one of central portions of the battery cells 200 connected in series and accommodated in a battery module, and the cooling fluid 350a is allowed to circulate along the flow path 250, thereby cooling the central portion, which is a portion of the battery cell 200 that is most severely heated, to improve the efficiency of cooling the battery pack 20.

Although the present disclosure has been described with limited embodiments and drawings, the present disclosure is not limited to thereto, and instead, it would be appreciated by those skilled in the art that various modifications and changes may be made to these embodiments without departing from the principles and spirit of the present disclosure, the scope of which is defined by the claims and their equivalents.

According to embodiments of the present disclosure, a flow path may be positioned at a central portion of battery cell accommodated in a battery pack to cool the battery cell, thereby improving cooling efficiency.

What is claimed is:

1. A battery pack comprising:
a case;
a plurality of battery cells which are accommodated in the case, are connected in series, and each has a flow path formed in a central portion thereof; and
a pump configured to circulate a cooling fluid along the flow path.

2. The battery pack of claim 1, wherein:
each of the plurality of battery cells comprises a cylindrical can including a bottom portion, and a cap assembly configured to cover one surface of the cylindrical can, and
an opening is formed in each of central portions of the bottom portion and the cap assembly so that the flow path, which passes through the central portion of the battery cell and is externally connected, is formed.

3. The battery pack of claim 2, wherein:
each of the plurality of battery cells further comprises a center pin positioned at the central portion, and
the center pin communicates with the opening of the cap assembly and the opening of the bottom portion.

4. The battery pack of claim 3, wherein the center pin has a hollow circular pipe shape.

5. The battery pack of claim 2, wherein:
a concave portion is positioned at the central portion of the bottom portion,
a protrusion is positioned at the central portion of the cap assembly,
the protrusion is disposed at one side of the flow path, and
the concave portion is disposed at another side of the flow path.

6. The battery pack of claim 5, wherein the plurality of battery cells connected in series are coupled such that the protrusion of each battery cell corresponds to the concave portion of a battery cell adjacent thereto.

7. The battery pack of claim 5, wherein:
the bottom portion is electrically connected to a negative electrode tab, and
the cap assembly is electrically connected to a positive electrode tab.

8. The battery pack of claim 6, wherein a plurality of guide portions are disposed along an outer circumference of the concave portion to be spaced apart from one another.

9. The battery pack of claim 8, wherein the plurality of guide portions are configured to guide the protrusion to be coupled to correspond to the concave portion.

10. The battery pack of claim 9, wherein one area of the protrusion is coupled to the concave portion, and the guide portion is welded to another area of the protrusion which is not coupled to the concave portion.

11. The battery pack of claim 6, wherein the protrusion is electrically connected to the concave portion.

12. The battery pack of claim 2, wherein an insulating plate is disposed between the cylindrical can and the cap assembly

13. A battery pack comprising:
a case;
a connection group comprising a plurality of battery cells which are accommodated in the case, are connected in series, and each has a flow path formed in a central portion thereof;
a first busbar disposed at one side of the connection group;
a second busbar disposed at another side of the connection group; and
a pump configured to circulate a cooling fluid along the flow path,
wherein a plurality of connection groups are disposed in the case, and the first busbar and the second busbar electrically connect the plurality of connection groups in parallel.

14. The battery pack of claim 13, wherein:
each of the plurality of battery cells comprises a cylindrical can including a bottom portion, and a cap assembly configured to cover one surface of the cylindrical can, and
an opening is formed in each of central portions of the bottom portion and the cap assembly so that the flow path, which passes through the central portion of the battery cell and is externally connected, is formed.

15. The battery pack of claim 14, wherein:
each of the plurality of battery cells further comprises a center pin positioned at the central portion, and
the center pin communicates with the opening of the cap assembly and the opening of the bottom portion.

16. The battery pack of claim 15, wherein the center pin has a hollow circular pipe shape.

17. The battery pack of claim 14, wherein:
a concave portion is positioned at the central portion of the bottom portion,
a protrusion is positioned at the central portion of the cap assembly,
the protrusion is disposed at one side of the flow path, and
the concave portion is disposed at another side of the flow path.

18. The battery pack of claim 17, wherein the plurality of battery cells connected in series are coupled such that the protrusion of each battery cell corresponds to the concave portion of a battery cell adjacent thereto.

19. The battery pack of claim 18, wherein the protrusion is electrically connected to the concave portion.

20. The battery pack of claim 17, wherein a plurality of guide portions are disposed along an outer circumference of the concave portion to be spaced apart from one another.
